(19) United States
(12) Patent Application Publication
(10) Pub. No.: US 2007/0263480 A1
(43) Pub. Date: Nov. 15, 2007

(54) MIXERS AND SCRAPERS

(75) Inventors: Wolfgang Saalmann, Magdeburg (DE); Reiner Lemperle, Paderborn (DE)

Correspondence Address: PEARNE & GORDON LLP, 1801 EAST 9TH STREET, SUITE 1200, CLEVELAND, OH, 44114-3108, US

(73) Assignee: Gebr. Lodige Maschinenbau-Gessellschaft mit beschrankter Haftung, Paderborn (DE)

(21) Appl. No.: 11/746,155

(22) Filed: May 9, 2007

(30) Foreign Application Priority Data
May 12, 2006 (DE) 10 2006 022660.7

(51) Int. Cl. B01F 7/04

(52) U.S. Cl. 366/99; 366/313

(57) ABSTRACT

The invention relates to a horizontal mixer with a cylindrical mixing vessel and a horizontal shaft located in the mixing vessel, which shaft is connected with at least one mixing tool and at least one scraper, with which a or the lowermost point of the interior of a mixer can be reached.

The invention relates to a mixer with scrapers.

EP 367968 A relates to a mixer comprising a mixing container, wherein a mixing tool is driven by a first vertical shaft, A scraper is driven via a second shaft so as to prevent permanent deposits of material to be mixed on interior walls. Despite the scraper, there is the risk in this known apparatus that the material to be mixed deposits permanently at the lowermost point of the mixing container. For constructional reasons, a scraper must be kept away from this area because mixing tools would collide with a scraper at the lowermost point. In addition, the apparatus known therefrom is neither intended for large-scale use, nor suitable for it,

Moreover, a mixer with scrapers is known from DE-OS 36 38 656. A central, vertical stirring shaft carries stirring blades that reach the areas of the inner walls of the mixing vessel. The lowermost point of the mixing container is not covered, so that permanent deposits of the material to be mixed can arise on the corresponding interior wall.

DE-OS 36 38 656 points out that the stirring tool with the scrapers is unsuitable for being able to mix high-viscosity material to be mixed. In that case, the stirring tool must be substituted with another tool. Moreover, the mixing device from DE-OS 36 38 656 is designed for relatively small mixing vessels of up to one liter, This mixing container is not suitable for a large-scale production.

It is the object of the invention to provide a mixer capable of preventing permanent deposits of the material to be mixed in particular also at the lowermost point of the mixing container.

The object is solved by a mixer having the features of claim 1. Advantageous embodiments become apparent from the dependent claims.

For solving the object, a horizontal mixer is chosen which has a cylindrical mixing container and a horizontal shaft that is connected with at least one mixing tool and at least one scraper. If we speak of the scraper or the mixing tool below, this, in principle, is also to comprise the case where several mixing tools or several scrapers are used analogously.

The scraper is made so as to be capable of reaching the or at least a lowermost point of the interior of the mixer in order to counteract deposits of the material to be mixed here. For constructional reasons, the mixing tool can run through the bottom or lowermost point of the interior without blocking this area all the time. Therefore, it is readily possible also to let the scraper come into this area.

In one embodiment of the invention, a stirring tool is provided that is capable of lifting the material to be mixed off from the lowermost point. Ploughshare blades, modified ploughshare blades and baker's shovels are examples for such a stirring tool, This embodiment contributes in an improved manner to the scraper and the mixing tool supporting each other for conveying material to be mixed away from the lowermost point and even the lowermost point being kept free from permanent deposits of the material to be mixed.

In one embodiment of the invention, the scraper is attached so as to be pressed against an interior wall of the mixing vessel by material to be mixed during mixing. To this end, the scraper and the adjacent interior wall enclose a small angle. Given an appropriately chosen direction of rotation, the material to be mixed, especially in the lowermost point, causes the scraper to lift off material to be mixed from the interior wall, even given large amounts of material to be mixed and/or high viscosity material to be mixed.

In one embodiment, a gap can remain between the scraper and the adjacent interior wall in the empty state of the mixer, It has been found that cleaning the interior is thus made easier, by adding a cleaning liquid into the interior and selecting such a direction of rotation of the scraper that the cleaning liquid is conveyed by the scraper in the direction towards the adjacent interior wall. Due to this gap, the cleaning liquid is given a very large turbulence that has a positive effect on the cleaning process.

In one embodiment, the scraper is attached in a positive fit. In this way, parts serving the purpose of fastening, such as bolts, are prevented from loosening. Fastening parts such as bolts consist of metal as a matter of principle. If such metallic small parts become detached, the fear is that they may cause damage. A scraper does not consist of metal, as a matter of principle, but generally of plastic. In the event the scraper is detached inadvertently, the danger of resulting damage is significantly less because of the material, A positive-fit connection is to be preferred over a force-fit connection so as to make the replacement of a scraper easier and in order to be able to obtain a certain mobility.

Preferably, the scraper consists of Teflon since that, as a rule, has an inert behavior with regard to the material to be mixed.

In order to accommodate a scraper in a particularly space-saving manner, it is attached, via an arm, with another arm on which a mixing tool is attached. Thus, the possible loading volume of the mixing vessel is affected minimally by the scraper.

Preferably, the scraper is attached on an arm which does not directly adjoin an end wall, Viewed from the arm, the scraper can then extend in two directions parallel to the adjacent interior wall. Thus, mechanically stable scrapers can successfully be provided with minimal constructional effort, Thus, it is possible to cover all interior walls of the mixer. In one embodiment of the invention, the mixer comprises at least two stirring tools, one stirring tool of which, respectively, adjoins one end wall, respectively. On the side of these two mixing tools adjoining the respective end wall, scrapers are also attached in order to also keep the end walls free from deposits. In that case, it need not be a horizontal mixer anymore in order to be able to cover the lowermost point of the mixing container.

In a container which advantageously lies horizontally, wherein a mixing mechanism rotates, which is also horizontal and centrally supported, a scraper system, according to the invention, can sweep over all interior surfaces of the container, touching them, In the process, the mixing mechanism takes over the task of homogenizing the product to be mixed, The scrapers ensure that no product adheres to the interior surfaces of the container. This is of significance in particular in the production of viscous to highly-viscous products because the scrapers ensure that the adhering product does not participate in the total mixture and that, additionally, the heat exchange between the container wall and the product is not inhibited if a product is brought to a certain temperature. Moreover, the amount of product remaining in the machine is considerably reduced when it is emptied.

The scraper fasteners are preferably welded, for the cylindrical part, to the mixing mechanism arms of the “full blades” of the mixing mechanism, as is apparent from the figures. The retainers for the scrapers on the side walls are attached directly on the “half blades”, as is also shown in the figures.

The actual scrapers are manufactured from product-compatible materials, e.g. Teflon. It is particularly advantageous that, on the one hand, the embodiment of the scrapers is designed such that they can be attached on the half or full blades without using tools, and that, on the other hand, it is ensured that when the product is produced, it presses the scrapers back towards the container wall, which causes the scraping effect. For cleaning the arrangement, the mixing mechanism is rotated in a direction opposite to the direction of rotation during production, after cleaning liquid has been given into the container. The scrapers are then not pressed against the container wall due to their shape, and a small gap is created between the mixing mechanism and the container. This causes a very good cleaning effect.

With this arrangement, providing scrapers in a container that lies horizontally is made possible. The scrapers can be retained on fasteners that afford a necessary mobility.

The figures further illustrate this particularly advantageous embodiment.

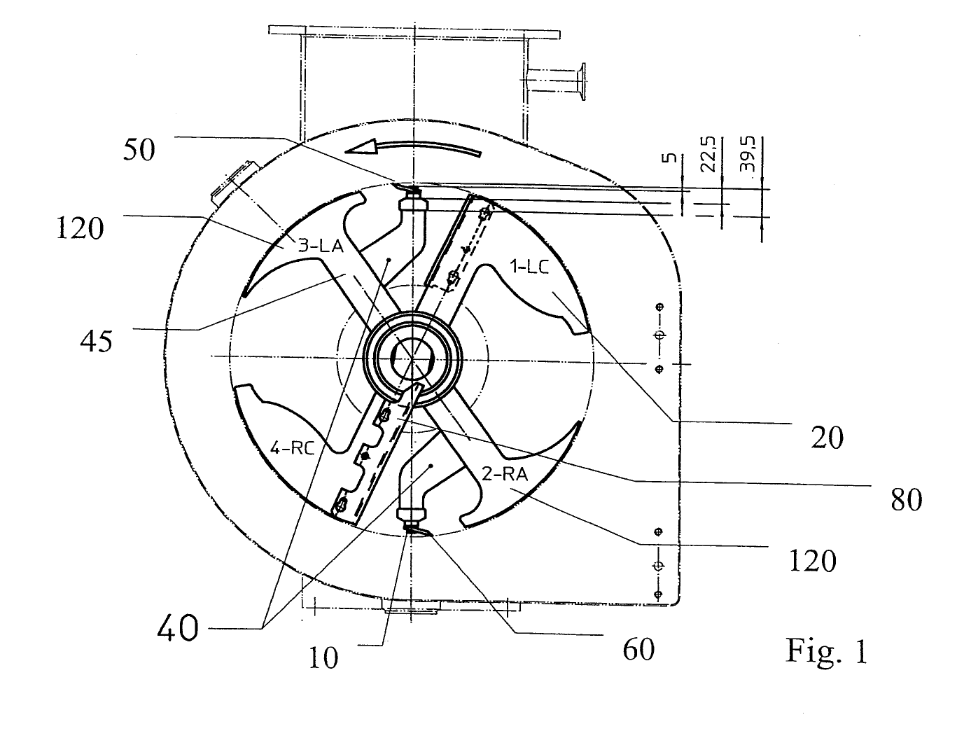

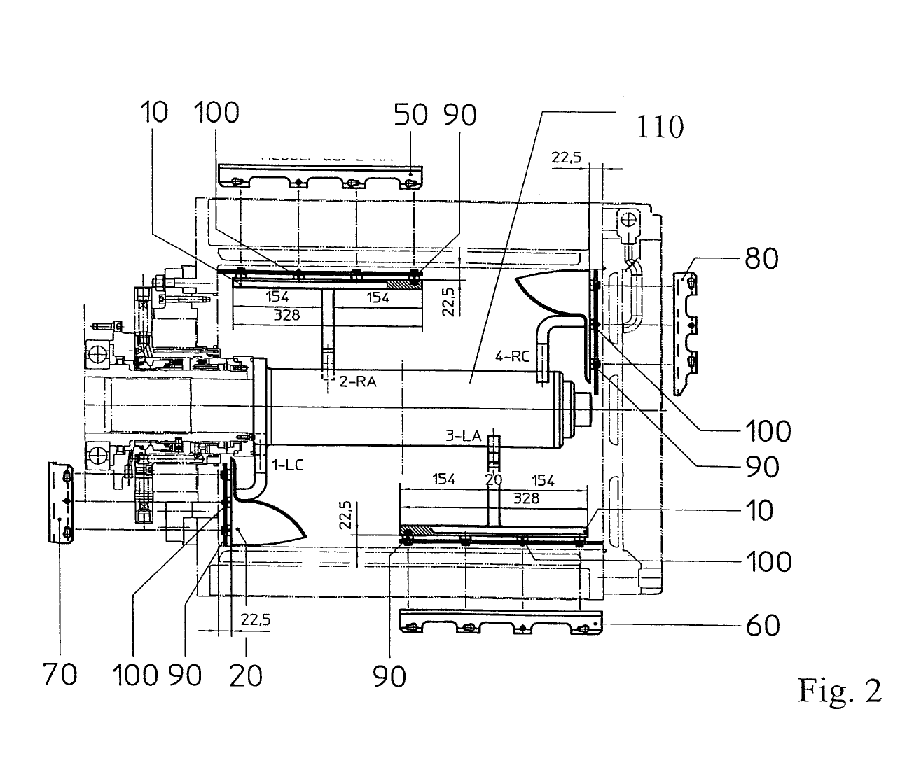

The FIGS. 1 and 2 are technical drawings of a mixer according to the invention.

FIG. 1 shows a view into the interior of a horizontal mixer through an end wall.

FIG. 2 shows another view through the cylinder jacket.

Scrapers 50, 60, 70 and 80 are attached by positive fit at positions 90 and 100 intended therefor by means of bayonet-like locks. The scrapers 70 and 80 are attached to half blades 20, so that they cover the end faces completely. The scrapers 50 and 60 are attached to separate fasteners 10 intended therefor so as to cover entirely the jacket form of the cylinder. The fasteners 10 are welded, via arms, to other arms 45. Near the interior wall, the arms 45 have full blades. The arms 45 are attached on a shaft 110. If the shaft 110 rotates in a direction indicated by an arrow in FIG. 1, then, at all interior surfaces of the cylindrical jacket, material to be mixed is conveyed away both by the mixing tools or full blades 120, as well as by the scrapers 50 and 60, away from the respectively adjoining wall, in particular also at the lowermost point, where the material to be mixed particularly tends to stick due to gravity. Both the half blades 20 as well as the scrapers 70 and 80 transport material to be mixed away from the end walls.

1. Horizontal mixer comprising a cylindrical mixing vessel and a horizontal shaft located in the mixing vessel, which shaft is connected with at least one mixing tool and at least one scraper with which a or the lowermost point of the interior of the mixer can be reached.

2. Horizontal mixer according to claim 1, wherein the mixing tool is such that it is capable of lifting off material to be mixed from the lowermost point.

3. Mixer according to claim 1, wherein the scraper is attached so as to be pressed against an interior wall of the mixing vessel by material to be mixed during mixing.

4. Mixer according to claim 3, wherein, in the idle state of the mixer, a gap remains between the scraper and the adjacent interior wall.

5. Mixer according to claim 1, wherein the scraper is attached in a positive fit.

6. Mixer according to claim 1, wherein the mixing vessel is cylindrical in shape, and one or more scrapers are dimensioned and arranged so that they cover the interior wall of the cylindrical jacket completely.

7. Mixer according to claim 1, wherein the scraper consists of Teflon.

8. Mixer according to claim 1, wherein a baker's shovel, a ploughshare blade and/or a modified ploughshare blade is used as a mixing tool.

9. Mixer according to claim 1, wherein the scraper, via an arm, is connected with another arm on which a mixing tool is attached.

10. Horizontal mixer according to claim 1, wherein the scraper is attached on an arm that does not directly adjoin an end wall.

11. Horizontal mixer according to claim 1, wherein at lease one stirring tool adjoins an end wall and wherein a scraper is attached on the side of the stirring tool that adjoins the end wall.

12. Method for cleaning a mixer according to claim 1, wherein a cleaning liquid is first filled into the interior of the mixer and the shaft is then rotated in a direction opposite to the direction of rotation that is provided for mixing.
